(19) United States
(12) Patent Application Publication
(10) Pub. No.: US 2025/0099921 A1
(43) Pub. Date: Mar. 27, 2025

(54) POLYPYRROLE-GRAPHITIC CARBON NITRIDE (PPY-G-C3N4) DECORATED POLYMERIC/CERAMIC COMPOSITE FILTRATION MEMBRANE

(71) Applicant: KING FAHD UNIVERSITY OF PETROLEUM AND MINERALS, Dhahran (SA)

(72) Inventors: Umair BAIG, Dhahran (SA); Abdul WAHEED, Dhahran (SA); Isam H. ALJUNDI, Dhahran (SA)

(73) Assignee: KING FAHD UNIVERSITY OF PETROLEUM AND MINERALS, Dhahran (SA)

(21) Appl. No.: 18/472,298

(22) Filed: Sep. 22, 2023

(51) Int. Cl. B01D 71/62; B01D 61/38; B01D 69/10; B01D 69/14; B01D 71/02

(52) U.S. Cl. CPC B01D 71/62; B01D 61/38; B01D 69/106; B01D 69/108; B01D 69/14111; B01D 69/144; B01D 69/145; B01D 71/025; B01D 2255/702; B01D 2257/702; B01D 2325/02834

(57) ABSTRACT

A filtration membrane includes an alumina support; a polyamide network disposed on the alumina support and formed by polycondensation between piperazine (PIP) and isophthaloyl dichloride (IPC); and a polypyrrole-graphitic carbon nitride (PPy-G-C₃N₄) photocatalyst embedded in the polyamide network through covalent bonding, the PPy-G-C₃N₄ photocatalyst including nanosheets of graphitic carbon nitride (G-C₃N₄) embedded in a matrix of a polypyrrole (PPy) polymer. The membrane of the present disclosure can be used for separating oil and water.

### STATEMENT OF ACKNOWLEDGEMENT

This invention was made with support provided by the IRC-MWS through project #INMW2313, KFUPM, Saudi Arabia.

### BACKGROUND

### Technical Field

The present disclosure is directed to a filtration membrane, particularly, a self-cleaning antifouling polypyrrole-graphitic carbon nitride (PPy-G-C₃N₄) decorated polymeric/ceramic composite filtration membrane.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Baig et al. (“Fabrication of polypyrrole-graphitic carbon nitride nanocomposite containing hyper-cross-linked polyamide photoresponsive membrane with self-cleaning properties for water decontamination and desalination applications,” Journal of Water Process Engineering, Volume 47, 102721) disclose a membrane including a hyper-cross-linked polyamide thin film formed on a polysulfone/polyethylene terephthalate (PSf/PET) membrane support. The film is formed by polymerizing a polypyrrole-graphitic carbon nitride nanocomposite with N,N-bis(2-aminoethyl)-1,3-propanediamine and terephthaloyl chloride. The membrane is used to remove inorganic salts, instead of oil, from water.

US20100224555A1 discloses a composite membrane including a film having an interfacially-polymerized polyamide matrix, such as residues of piperazine and isophthaloyl halide. While the membrane can also include a hydrophilic layer such as polyvinyl pyrrole, polyvinyl pyrrole is not polypyrrole. Moreover, there is no photocatalyst in the membrane.

WO2022252484A1 discloses a film prepared by reacting an ionic liquid of a monomer (a) with another monomer (b). (a) can be an amine (e.g. piperazine), alcohol, phenolic compound, hydrogen peroxide, etc. (b) can be an acyl chloride (isophthaloyl chloride), pyrrole, aldehyde, isocyanate, etc. Therefore, the film can be made of polyamide, polypyrrole, polyester, polyurea, etc. However, this synthetic method does not lead to a polypyrrole embedded in a polyamide formed of piperazine and isophthaloyl dichloride. Moreover, there is no photocatalyst in the membrane.

CN111018041A discloses a photocatalyst, including polypyrrole and graphite-phase carbon nitride, and a method of using this photocatalyst to remove uranium from wastewater. However, this photocatalyst is added as a solid to form a suspension with the wastewater, instead of being used as a membrane. Moreover, this reference does not teach covalently bonding the photocatalyst to a polyamide membrane or cleaning the polyamide membrane.

CN109585178A discloses a supercapacitor formed of a polypyrrole/graphite-type carbon nitride electrode material, which is a solid obtained by filtering a suspension. There is no mention of membrane technology or water purification.

U.S. Ser. No. 11/040,313B2 discloses a super-hydrophilic/underwater super-oleophobic separation membrane, including ferroferric oxide composite nanoparticles dispersed in polyacrylamide and methylcellulose.

Hayat et al. (“Visible-light enhanced photocatalytic performance of polypyrrole/g-C₃N₄ composites for water splitting to evolve H2 and pollutants degradation”) disclose a polypyrrole/g-C3N4 nanocomposite formed by a wet chemical method. The photocatalytic activities of the composites are evaluated for water splitting and dye degradation under visible light. However, Hayat et al. do not teach membrane technology.

It is challenging to treat oily waste water streams, which are released as oil/water (0/W) emulsions from various sources such as domestic and industrial effluents. The O/W emulsion is often highly stable due to surfactants in the emulsion. The primary source of oily waste water is produced water (PW) which is generally released from the oil and gas industry. On the one hand, such an industry releases huge quantities of oily waste water. On the other hand, the oil and gas industry requires immense amounts of clean and potable water to maintain its several operations.

Various strategies have been proposed and utilized for treating oily waste water streams. These technologies include both physical and chemical methodologies for treating oily waste water. Moreover, these technologies have been categorized into primary and secondary techniques, which are applied based on the nature and location of the oily waste water. Primary treatment technologies include hydrocyclones, corrugated plate separators, American Petroleum Industry (API) separators, or the like while secondary treatment technologies include induced gas floatation (IGF), dissolved gas floatation (DGF), dissolved air floatation (DAF), dissolved nitrogen floatation (DNF), and compact floatation unit (CFU). These technologies are generally applied to reduce oil concentrations in the treated PW to 30 to 40 ppm. Unfortunately, the combination of primary and secondary technologies cannot reduce the oil concentration of the treated PW to a level that meets the regulations set by environmental agencies.

The development of membranes has played a significant role in treating a variety of waste water streams such as microfiltration (MF), ultrafiltration (UF), nanofiltration (NF), and reverse osmosis (RO) membranes are used at different stages of water treatment. Generally, UF membranes are used for treating oily waste water. The O/W emulsion separation efficiency of a UF membrane depends on the surface wettability features of the membranes. The surface hydrophilicity and hydrophobicity are critical in separating oil from water. The performance of the UF membrane can be tuned by varying the membrane surface wettability from hydrophilic-oleophobicity to hydrophobic-oleophilicity. Hydrophilic-oleophobic membranes allow preferably water to pass through the membrane while oil is rejected from the membrane surface. Alternatively, a UF membrane with hydrophobic-oleophilicity enable oil to pass through the membrane while water is rejected from the membrane surface. Another mode of surface wettability is underwater superoleophobicity, a condition where the oil cannot wet the membrane surface. At the same time, water is passed through the membrane under filtration conditions.

A hydrophobic membrane was designed to remove oil from water where the membrane allowed oil to pass through the membrane while the membrane rejected water. The membrane was developed using a graphene-wrapped polyphenylene sulfide fiber, which enhanced chemical resistance and hydrophobicity. The resultant membrane was able to remove heavy oil from the O/W emulsion. Similarly, another hydrophobic membrane was developed using polyvinylidene difluoride (PVDF) coated with eggshell and sodium alginate. The resultant PVDF membrane was able to remove oil from the O/W emulsion. Although such hydrophobic membranes can separate the oil, they can be fouled quickly due to the oil wetting the membrane surface. Hence, superhydrophilic membranes are developed to remove water from the O/W emulsions. In one such example, Liu et al. developed a mesh membrane by coating the membrane surface through the electrospinning of a cigarette filter. The membrane was able to separate the water from the O/W emulsion [Liu, W.; Cui, M.; Shen, Y.; Zhu, G.; Luo, L.; Li, M.; Li, J. Waste Cigarette Filter as Nanofibrous Membranes for On-Demand Immiscible Oil/Water Mixtures and Emulsions Separation. J. Colloid Interface Sci. 2019, 549, 114-122].

Even though several efforts have been adopted to fabricate membranes with special wettability features, the fouling of the membrane surface is unavoidable under filtration conditions. Hence, efforst were undertaken to develop smart and effective membranes with special surface features such as antifouling and self-cleaning properties.

In one such example, Liu et al. fabricated a thermo-responsive membrane by decorating the membrane surface with poly(N-isopropylacrylamide) (PNIPAM) with the surface-initiated atom transfer radical polymerization (SI-ATRP) [Liu, Y.; Lu, H.; Li, Y.; Xu, H.; Pan, Z.; Dai, P.; Wang, H.; Yang, Q. A Review of Treatment Technologies for Produced Water in Offshore Oil and Gas Fields. Sci. Total Environ. 2021, 775, 145485].

Such a thermoresponsive membrane showed an antifouling performance upon exposure to changes in ambient temperature. Although smart, responsive membranes show potential in treating oily waste water, there are several challenges in this regard, such as tedious reaction conditions, high material costs, and high energy consumption. Therefore, there is a need to discover highly efficient and effective ways to fabricate new membranes that can mitigate fouling issues while possessing chemical resistance and stable performance during filtration experiments.

Each of the methods and membranes above suffers from one or more drawbacks hindering their adoption. Accordingly, it is one object of the present disclosure to develop an efficient membrane that can work sustainably under filtration conditions with the ability to tackle the most pressing issues of membrane fouling.

### SUMMARY

In an exemplary embodiment, a filtration membrane is described. The filtration membrane includes an alumina support; a polyamide network disposed on the alumina support and formed by polycondensation between piperazine (PIP) and isophthaloyl dichloride (IPC); and a polypyrrole-graphitic carbon nitride (PPy-G-C₃N₄) photocatalyst embedded in the polyamide network through covalent bonding, the PPy-G-C₃N₄ photocatalyst comprising nanosheets of graphitic carbon nitride (G-C₃N₄) embedded in a matrix of a polypyrrole (PPy) polymer.

In another exemplary embodiment, a method of water and oil separation is described. The method includes filtering a mixture of water and oil through a filtration membrane to generate a water permeate. The filtration membrane comprises an alumina support, a polyamide network disposed on the alumina support and formed by polycondensation between piperazine (PIP) and isophthaloyl dichloride (IPC), and a polypyrrole-graphitic carbon nitride (PPy-G-C₃N₄) photocatalyst embedded in the polyamide network through covalent bonding, the PPy-G-C₃N₄ photocatalyst comprising nanosheets of graphitic carbon nitride (G-C₃N₄) embedded in a matrix of a polypyrrole (PPy) polymer.

In another exemplary embodiment, a non-transitory computer-readable medium having instructions stored therein that, when executed by one or more processors, cause the one or more processors to perform a method of separating oil and water with a filtration membrane. The filtration membrane includes an alumina support; a polyamide network disposed on the alumina support and formed by polycondensation between piperazine (PIP) and isophthaloyl dichloride (IPC); and a polypyrrole-graphitic carbon nitride (PPy-G-C₃N₄) photocatalyst embedded in the polyamide network through covalent bonding, the PPy-G-C₃N₄ photocatalyst comprising nanosheets of graphitic carbon nitride (G-C₃N₄) embedded in a matrix of a polypyrrole (PPy) polymer.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary flowchart of a method of making a membrane, according to certain embodiments.

FIG. 2 is a schematic diagram of a process adopted during the fabrication of a polypyrrole-graphitic carbon nitride (PPy-G-C₃N₄) in a polyamide (PA) network (PPy-G-C₃N₄/PA) on an alumina ceramic support (PPy-G-C₃N₄/PA@alumina ceramic membrane), according to certain embodiments.

FIG. 3 is an exemplary illustration of a proposed reaction during an interfacial polymerization (IP) and the expected structure of the PPy-G-C₃N₄/PA active layer, according to certain embodiments.

FIG. 4A is an X-ray Diffraction pattern (XRD) of graphitic carbon nitride (G-C₃N₄), according to certain embodiments.

FIGS. 4B, 4C and 4D are high-resolution transmission electron microscope (HRTEM) images of the G-C₃N₄, according to certain embodiments.

FIG. 4E is a selected area electron diffraction (SAED) of the G-C₃N₄, according to certain embodiments.

FIG. 5A is a Fourier Transform Infrared (FTIR) spectrum of the PPy-G-C₃N₄ composite, according to certain embodiments.

FIG. 5B and FIG. 5C show scanning electron microscope (SEM) images of the PPy-G-C₃N₄ composite, according to certain embodiments.

FIG. 5D is an energy-dispersive X-ray spectroscopy (EDX) analysis of the PPy-G-C₃N₄ composite, according to certain embodiments.

FIG. 6 shows Attenuated Total Reflectance-Fourier Transform Infrared (ATR-FTIR) spectra of the bare alumina ceramic support and the PPy-G-₃N₄/PA@alumina ceramic membrane, according to certain embodiments.

FIG. 7 is a wide-angle XRD pattern of the alumina ceramic support and the PPy-G-C₃N₄/PA@alumina ceramic membrane, according to certain embodiments.

FIGS. 8A, 8B and 8C show SEM micrographs of the bare alumina ceramic support, according to certain embodiments.

FIGS. 8D, 8E and 8F show SEM micrographs of the PPy-G-C₃N₄/PA@alumina ceramic membrane, according to certain embodiments.

FIG. 9A and FIG. 9B show EDX analyses of the alumina ceramic membrane, according to certain embodiments.

FIG. 9C and FIG. 9D show EDX analyses of the PPy-G-C₃N₄/PA@alumina ceramic membrane, according to certain embodiments.

FIG. 10 depicts water contact angle (WCA) and oil contact angle (OCA) in air and OCA underwater of the PPy-G-C₃N₄/PA@alumina ceramic membrane, according to certain embodiments.

FIG. 11 is a graph showing pure water permeate flux of the PPy-G-C₃N₄/PA@alumina ceramic membrane as a function of applied transmembrane pressure, according to certain embodiments.

FIG. 12A is a graph showing effect of pressure on permeate flux of the PPy-G-C₃N₄/PA@alumina ceramic membrane, using 100 ppm oil-in-water (O/W) emulsion as feed, according to certain embodiments.

FIG. 12B is a graph showing the effect of pressure on separation efficiency of the PPy-G-C₃N₄/PA@alumina ceramic membrane, using 100 ppm O/W emulsion as feed, according to certain embodiments.

FIG. 13A is a graph showing effect of different oil concentrations, in O/W emulsion, on permeate flux of the PPy-G-C₃N₄/PA@alumina ceramic membrane at 4 bar, according to certain embodiments.

FIG. 13B is a graph showing effect of different oil concentrations, in O/W emulsion, on separation efficiency of the PPy-G-C₃N₄/PA@alumina ceramic membrane at 4 bar, according to certain embodiments.

FIGS. 14A, 14B and 14C show digital photographs of feed having 50 ppm, 100 ppm, and 200 ppm, O/W emulsion, respectively, according to certain embodiments.

FIGS. 14D, 14E and 14F show optical microscopic images of feed having 50 ppm, 100 ppm, and 200 ppm, O/W emulsion, respectively, according to certain embodiments.

FIGS. 14G, 14H and 14I show optical microscopic images of permeate collected from the feed having 50 ppm, 100 ppm, and 200 ppm, O/W emulsion, respectively, during filtration experiments using PPy-G-C₃N₄/PA@alumina ceramic membrane at 4 bar, according to certain embodiments.

FIG. 15A is a stability filtration test of the PPy-G-C₃N₄/PA@alumina ceramic membrane, using permeate flux as an indicator, with 100 ppm O/W emulsion as feed at 4 bar, according to certain embodiments.

FIG. 15B is a stability filtration test of the PPy-G-C₃N₄/PA@alumina ceramic membrane, using separation efficiency as a metric, with 100 ppm O/W emulsion as feed at 4 bar, according to certain embodiments.

FIG. 16 is a graph showing photocatalytic self-cleaning of a fouled PPy-G-C₃N₄/PA@alumina ceramic membrane using 100 ppm O/W emulsion as feed at 4 bar, according to certain embodiments.

FIG. 17 is a schematic representation depicting a proposed mechanism for the separation of O/W emulsion based on the surface wettability of the PPy-G-C₃N₄/PA@alumina ceramic membrane, according to certain embodiments.

FIG. 18 is a schematic representation depicting a proposed mechanism for photocatalytic self-cleaning of a fouled PPy-G-C₃N₄/PA@alumina ceramic membrane, using 100 ppm O/W emulsion as feed at 4 bar, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “solvent” will be well understood by a skilled artisan and includes an organic or aqueous liquid. It is understood that the term solvent also includes a mixture of solvents. Non-limiting examples of solvents include aromatics, alkanes, ketones, glycols, chlorinated solvents, esters, ethers, amines, nitriles, aldehydes, phenols, amides, carboxylic acids, alcohols, furans, and polar protic and polar aprotic solvents, water, and mixtures thereof. Specific examples of solvents include toluene, xylene, benzene, styrene, anisole, chlorobenzene, dichlorobenzene, chloroform, dichloromethane, dichloroethane, methyl acetate, ethyl acetate, butyl acetate, methyl ether ketone (MEK), methyl iso butyl ketone (MIBK), acetone, ethylene glycols, ethanol, methanol, propanol, butanol, hexane, cyclohexane, dimethoxyethane, methyl tert butyl ether (MTBE), diethyl ether, adiponitrile, N, N dimethylformamide, dimethylsulfoxide, N,N dimethylacetamide, dioxane, nitromethane, nitrobenzene, pyridine, carbon disulfide, tetrahydrofuran, methyltetrahydrofuran, N-methyl pyrrolidone, acetonitrile, water, and mixtures thereof.

As used herein, the term “surfactant” refers to an organic or inorganic chemical that, when added to a liquid, changes the properties of that liquid at a surface.

Aspects of this disclosure are directed to a photocatalytic self-cleaning composite alumina ceramic membrane, also referred to as a membrane, by decorating the membrane's active layer with a PPy-G-C₃N₄ composite. The PPy-G-C₃N₄ composite was embedded in the polyamide active layer through interfacial polymerization (IP). Due to the presence of numerous —NH functional groups in the PPy-G-C₃N₄ composite, a covalent bond can be formed between the composite and polyamide network. The developed membrane was evaluated for its self-cleaning properties. The evaluation was performed by exposing a fouled membrane to solar-simulated light. It was observed that the fouled membrane could recover 90% of its initial permeate flux after exposure to solar-simulated light, confirming its photocatalytic self-cleaning properties, thereby mitigating the issue of severe membrane fouling.

A filtration membrane is described. The membrane includes an alumina support; a polyamide network disposed on the alumina support preferably formed by polycondensation between piperazine (PIP) and isophthaloyl dichloride (IPC); and a polypyrrole-graphitic carbon nitride (PPy-G-C₃N₄) photocatalyst embedded in the polyamide network preferably through covalent bonding. The PPy-G-C₃N₄ photocatalyst includes nanosheets of graphitic carbon nitride (G-C₃N₄) embedded in a polypyrrole (PPy) polymer matrix.

The alumina support includes alumina particles in the form of nanocrystalline powders. In a preferred embodiment, the alumina particles have an average size of 1 to 10 μm, preferably 2.5-7.5 μm, preferably about 5 μm. The alumina particles are dispersed to form a structure with pores with the largest dimension of 0.2 to 3 μm, preferably 1 to 2 μm, preferably about 1.5 μm. The alumina particles in the alumina support may be similarly or differently sized. The alumina particles in the alumina layer may exist in different forms, such as alpha-alumina, delta-alumina, gamma-alumina, or combinations thereof, in the alumina support. In a preferred embodiment, the alumina support has alumina particles in γ form. γ-Al₂O₃ can be formed by heating boehmite AlO(OH) between 400 and 500° C., preferably 425-475° C., preferably about 450° C. It has a specific surface area >100 m²/g, preferably 100-300 m²/g, preferably 150-250 m²/g, preferably about 200 m²/g. Upon heating, adjacent OH groups can react to release water. The support may be adapted to form microfiltration, nanofiltration, or ultrafiltration support.

Optionally, the alumina support may include other particles such as titania (TiO₂), silica (SiO₂), zirconia (SiO₂), or a mixture of these materials. In some embodiments, the alumina support may include a combination of these materials—for example, Al₂O₃—ZrO₂. In an embodiment, the alumina support may include one or more layers, each including alumina particles of different pore sizes. In an embodiment, each layer from one or more layers may be made of the same or different material. For example, a first layer may be made of Al₂O₃ material, while a second layer in the alumina support may be made up of Al₂O₃—ZrO₂. The alumina support may exist in different shapes—such as tubular, monolith, hollow fiber, and flat sheet.

The membrane further includes a polyamide (PA) network disposed on the alumina support and formed by polycondensation between piperazine (PIP) and IPC, preferably is substantially equimolar amounts. Piperazine is used as a bifunctional monomer, and IPC is used as a bifunctional monomer as well. Both monomers are bifunctional, so the resulting polymer is generally linear, e.g., extending in a single dimension, and hence the membrane has a loose structure, compared with conventional PA networks where a tetra-amine leads to a highly crosslinked and tight network (see for example Baig et al., “Fabrication of polypyrrole-graphitic carbon nitride nanocomposite containing hyper-cross-linked polyamide photoresponsive membrane with self-cleaning properties for water decontamination and desalination applications”, Journal of Water Process Engineering, Volume 47, June 2022, 102721).

The PA network preferably consists of or consists essentially of reacted units of the piperazine (PIP) and IPC monomer units. In other aspects the PA network may contain minor amounts of one or more comonomers. A PIP-type comonomer in an amount of 5 mol % or less, preferably 2 mol % or less, 1 mol % or less, or 0.5 mol % or less based on the total moles of the PIP monomer. Similarly, an IPC-type comonomer may be present in an amount of 5 mol % or less, preferably 2 mol % or less, 1 mol % or less, or 0.5 mol % or less based on the total moles of the ITC monomer.

In some embodiments, the polycondensation reaction may be carried out with one or more optionally substituted piperazine derivatives and phthaloyl chlorides. Examples of substituted piperazine derivatives include, but are not limited to, 2-methylpiperazine, 2,5-dimethylpiperazine, N,N-bis(2-aminoethyl)-1,3-propanediamine, and or mixtures thereof. Suitable examples of phthaloyl chlorides include, but are not limited to, terephthaloyl chloride, isophthaloyl chloride, adipoyl chloride, or ethylene bis(chloroformate), and/or mixtures thereof. In a preferred embodiment, the polycondensation reaction is carried out between piperazine and isophthaloyl chloride. In another embodiment, the phthaloyl chloride is terephthalyol chloride. Optionally, other acid chlorides, such as oxyalyl chloride, succinoyl chloride, glutaryl chloride, adipoyl chloride, fumaryl chloride, itaconyl chloride, 1,2-cyclobutanedicarboxylic acid chloride, ortho-phthaloyl chloride, meta-phthaloyl chloride, terephthaloyl chloride, 2,6-pyridinedicarbonyl chloride, p,p′-biphenyl dicarboxylic acid chloride, naphthalene-1,4-dicarboxylic acid chloride, naphthalene-2,6-dicarboxylic acid chloride, and/or mixtures thereof may be used as well, preferably in a minor amount based on the total amount of the phthaloyl chloride.

In some embodiments, the piperazine and/or the optionally substituted piperazine derivative is employed as an aqueous solution. The concentration of the piperazine is around 0.1 to 10% by weight, preferably about 0.5 to 8% by weight, preferably about 1-5% by weight, preferably about 2 to 4% by weight, preferably about 2% by weight. The phthaloyl chloride is preferably dissolved in a nonpolar solvent. The concentration of the phthaloyl chloride in the solvent is about 0.01 to 10% by weight, preferably about 0.1 to 5%, preferably about 1 to 3%. A concentration ratio of the piperazine to the phthaloyl chloride is from 1:2 to 2:1, preferably from 2:3 to 3:2, preferably from 3:4 to 4:3, preferably from 4:5 to 5:4, preferably about 1:1. The polycondensation reaction may be carried out around room temperature, about 10 to 30° C., preferably about 20-25° C.

The membrane further includes a polypyrrole-graphitic carbon nitride (PPy-G-C₃N₄) photocatalyst embedded in the PA network through covalent bonding. Although pristine G-C₃N₄ is a promising photocatalyst, it suffers from rapidly recombining photo-generated electron-hole pairs. To overcome this drawback, the G-C₃N₄ is preferably mixed with one or more p-type semiconductors to form p-n heterojunction photocatalysts.

An ideal p-type material to composite with G-C₃N₄ (n-type) is polypyrrole (PPy), which is a p-type semiconductor, to form a visible light-driven p-n heterojunction photocatalyst. The PPy-G-C₃N₄ photocatalyst includes graphitic carbon nitride (G-C₃N₄) nanosheets and a polypyrrole (PPy) polymer. Optionally, other p-type polymers may be used/substituted along with PPy. The PPy polymer is covalently bonded to the polyamide network through a reaction between an amino group of the PPy polymer and an acyl chloride of the polyamide network.

The G-C₃N₄ is embedded into the matrix of the PPy polymer. In some embodiments, the nanosheets of G-C₃N₄ are embedded in the matrix of the PPy polymer through hydrogen bonding. The photocatalytic layer embodies the salient features of both components (G-CN and PPy), such as the photocatalytic potential of G-CN and light light-gathering capability of PPy, which augments the photocatalytic potential of G-CN.

PPy is generally synthesized by chemical or electrochemical means. Chemical synthesis involves mixing a strong oxidizing agent (typically FeCl₃ or any other oxidizing agent conventionally used in the art) with a monomeric or oligomeric solution of pyrrole to form the PPy. Pyrrole is a well-known H-bond donor; therefore, it can develop sufficient H-bonding with oxygen atoms of alumina, leading to the deposition of a stable PPy active layer on the alumina support. Examples of strong oxidants include the cations Fe³⁺, Cu²⁺, and Ce⁴⁺. The degree of polymerization of the pyrrole monomer on the alumina support was adjusted by regulating the concentration of the polymerization agent, temperature, and the polymerization period.

Graphitic carbon nitride may be procured commercially or prepared by any conventional methods known in the art. In some embodiments, the bulk-G-C₃N₄ was synthesized by thermal pyrolysis with melamine as the starting material. Certain other precursors include dicyandiamide, cyanamide, urea, thiourea, and ammonium thiocyanate. Different types of carbon nitrides such as α-C₃N₄, β-C₃N₄, cubic C₃N₄, pseudocubic C₃N₄, or mixtures may be used to prepare the PPy-G-C₃N₄. In an embodiment, the concentration of the PPy-G-C₃N₄ in the PA network is in a range of 0.01%-1 wt. %, preferably 0.05-0.5 wt. %, preferably 0.10-0.25 wt. %.

The membrane of the present disclosure can be used for oil-water separation. One of the advantages of the membrane of the present disclosure is its loose structure in the polyamide network. Since oil droplets are typically bigger compared to salts and other organic pollutants, the loose polymeric active layer can excellently perform the job of separating oil/water emulsion while providing a higher permeate flux. The loose structure may be reflected in a bulk morphology similar to a sintered material. Nodules of the PA polymer, tightly bound to one another, form channels and provide access to pores in the membrane. The nodules present a rough and irregular outer membrane surface. The outer membrane surface may have nodular protrusions extending to a height of 35 μm, preferably from 5-25 μm or about 10 μm. Individual nodules in semi-spherical form with rough outer surfaces have a diameter of 1-10 μm, preferably 2-5 μm. In comparison to a conventional membrane having a dense polyamide layer, the density (g/cm³) of the membrane of the present disclosure is preferably 0.8-1.05 g/cm³ or 0.9-1.0 g/cm³.

A filtration membrane for the separation of oil-water mixtures is described. Oil and water mixtures are generally observed in waste water, produced water, or seawater after an oil spill, rendering the water unfit for human/animal life. The membrane of the present disclosure allows for the separation of oil from water by selectively enabling the passage of water, leaving behind the oil, when the water is passed through the membrane. It is desirable for the membrane to have an extremely hydrophilic character underwater to bring about such a separation.

During operation, a mixture of water and oil is filtered by passing the mixture through the filtration membrane. The oil-water mixture includes one or more oils. Suitable examples include toluene, hexane, cyclohexane, dichloromethane, plant oil, isooctane, lubricating, motor, crude, diesel, and gasoline. In some embodiments, the mixture may be emulsified before passing the mixture through the filtration membrane. The purpose of emulsifying the mixture is to break the oil into tiny droplets, resulting in the distribution of the oil droplets in the water. In some embodiments, an emulsifying agent may be added to emulsify the mixture. Suitable examples of emulsifying agents include lecithin, soy lecithin, diacetyl tartaric acid ester of monoglyceride, mustard, sodium stearoyl lactylate, sodium phosphates, and/or combination thereof. The micro-sized oil droplets after the emulsification process have an average diameter of 10-100 μm, preferably 30-80 μm, preferably 40-70 μm, preferably 50-60 μm. After emulsification, the mixture of water and oil is filtered by passing the mixture through the filtration membrane. The membrane selectively allows the passage of water through the pores of the membrane by letting the water pass through to generate a water permeate, leaving behind oil. After filtration, the permeate passing through the filtration membrane is collected. The collected permeate is a purified permeate with a reduced amount of oil. In an embodiment, the purified permeate has <30% of oil, preferably <25%, preferably <20%, preferably <16%, preferably <10%, and preferably <5% of oil.

Another principle, apart from porosity, that affects the separation process is the hydrophilicity of the membrane underwater. The membrane is superhydrophilic and superoleophilic in air and superoleophobic underwater. As used herein, “superhydrophilic” refers to the phenomenon of excess hydrophilicity or attraction to water; in superhydrophilic materials, the contact angle of water is substantially or approximately equal to zero degree, and “superoleophobic” refers to a phenomenon where the contact angles of various oil droplets with low surface tension on a solid surface are larger than 150°, preferably larger than 160°, preferably larger than 170°. In these membranes, water is attached to the membrane surface to form an oleophobic liquid barrier, preventing oil droplets from seeping through, thereby separating oil and water. As a result of the underwater oleophobicity and low adhesion to oil, the superhydrophilic material has an excellent underwater antifouling property so that the problem of filter pores being blocked by oil is avoided.

The membrane was further tested for its photocatalytic self-cleaning activity. For this purpose, a fouled membrane was exposed to solar-simulated visible light or ultraviolet light. A fouled membrane refers to a process by which oil particles, colloidal particles, or solute macromolecules are deposited or adsorbed onto the membrane pores or onto a membrane surface by physical and chemical interactions or mechanical action, which results in smaller or blocked membrane pores. In a preferred embodiment, the PPy-G-C₃N₄ can impart photocatalytic activity to the membrane under visible light. In an embodiment, the membrane is self-cleaning under solar-simulated visible light irradiation conditions. Self-cleaning is possible, provided that the membrane is irradiated for at least 1 hour. In some embodiments, the method of self-cleaning the membrane includes exposing the filtration membrane to ultraviolet light to remove oil accumulated on the filtration membrane during the filtering process. The cleaned membrane may be re-used for filtration.

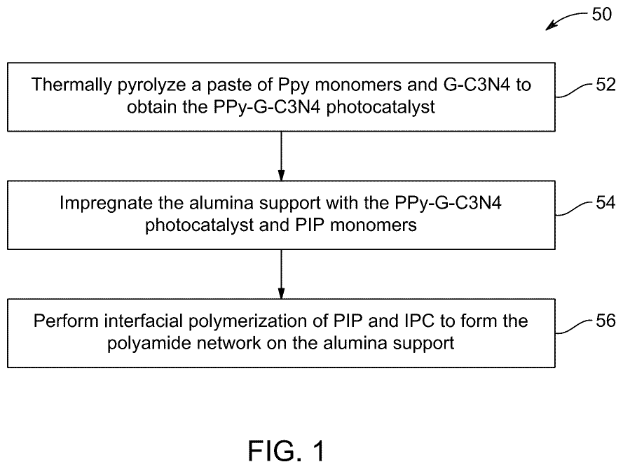

Referring to FIG. 1, a schematic flow diagram of a method 50 of making a membrane is illustrated. The order in which the method 50 is described is not intended to be construed as a limitation, and any number of the described method steps may be combined in any order to implement the method 50. Additionally, individual steps may be removed or skipped from the method 50 without departing from the spirit and scope of the present disclosure.

At step 52, the method 50 includes thermally pyrolyzing a paste of Ppy monomers and G-C₃N₄ to obtain the PPy-G-C₃N₄ photocatalyst. Thermal pyrolysis is carried out by placing the paste in a furnace such as a tube furnace, for example, in a ceramic crucible (e.g., an alumina crucible) or other forms of containment, and heating to the temperatures described above. The furnace is preferably equipped with a temperature control system, which may provide a heating rate of up to 50° C./min, or preferably up to 40° C./min, or preferably up to 30° C./min, preferably up to 20° C./min, preferably up to 10° C./min, preferably up to 5° C./min. The furnace may also be equipped with a cooling accessory such as a cooling air stream system or a liquid nitrogen stream system, which may provide a cooling rate of up to 20° C./min, or preferably up to 15° C./min, or preferably up to 10° C./min. The pyrolysis is carried out at a temperature range of 300-400° C., preferably 310-390° C., preferably 320-380° C., preferably 330-370° C., preferably 340-350° C., and more preferably 350° C. for 20-36 hours, preferably 22-32 hours, preferably 24-30 hours, preferably 24 hours, to obtain the PPy-G-C₃N₄ photocatalyst.

At step 54, the method 50 includes impregnating the alumina support with the PPy-G-C₃N₄ photocatalyst and PIP monomers. The impregnation of the PPy-G-C₃N₄ photocatalyst and PIP monomers to the alumina support can be carried out by any conventional means, such as casting the piperazine solution on the support, dipping, or immersing the support in the piperazine solution or spraying the solution on the support. Particularly, a preferred method for the application of the piperazine solution to the alumina support is by placing the alumina support in the piperazine solution for a time sufficient to permit complete saturation of the alumina support with the PPy-G-C₃N₄ photocatalyst and PIP. The excess solution may be removed by conventional means, such as rolling or pressing at pressures sufficient to remove the excess solution without damaging the support. In an embodiment, the impregnation is carried out in a nitrogen atmosphere at a pressure of about 1 bar.

At step 56, the method includes performing interfacial polymerization of PIP and IPC to form the polyamide network on the alumina support. The interfacial polymerization may be carried by contacting the membrane obtained at step 52 with a phthaloyl chloride (preferably isophthaloyl chloride (IPC)), which acts as a cross-linker. The IPC was dissolved in n-hexane to form the organic solution. The concentration of IPC in the n-hexane ranges from 0.1-1 wt./v %, preferably 0.2-0.5 wt./v %, preferably about 0.2 wt./v %. During the interfacial polymerization process, a reaction occurs between amino groups (—NH) of PIP and acid chloride (—COCl) of IPC, forming a polyamide with linear chains. The PPy polymer is covalently bonded to the polyamide network through a reaction between one or more amino groups of the PPy polymer and an acyl chloride/acid chloride (—COCl) of the polyamide, therefore forming a cross-linked network. Moreover, due to the presence of multiple amino groups (—NH) in the structure of pyrrole units of PPy and triazine unit of G-C₃N₄, the reaction also occurs between PPy-G-C₃N₄ and IPC, resulting in its stable decoration in the polyamide network. Similarly, multiple hydrogen bonds are possible between PPy-G-C₃N₄ and the polyamide active layer.

The membrane of the present disclosure demonstrated an underwater oil contact angle (OCA) (θ_{O,W}) of for example 159.97°. Even though the membrane surface features do not allow the oil to wet the membrane surface during filtration, the membrane surface fouling was inevitable during filtration experiments. With DI water as feed, the permeate flux of the membrane reached 650 L m⁻² h⁻¹ (LMH) at a pressure of 8 bar with a separation efficiency of >99%. With O/W emulsion, the flux decreased from 92 LMH to 50 LMH after 60 minutes of filtration tests. However, after exposure to solar-simulated light, the membrane recovered 90% of its permeate flux. The results suggest that the decoration of a specific photocatalyst (PPy-G-C₃N₄) in the active layer of the membrane can yield a self-cleaning membrane to mitigate the severe issue of membrane fouling.

### EXAMPLES

The following examples demonstrate the filtration membrane as described herein. The examples are provided solely for illustration and are not to be construed as limitations of the present disclosure, as many variations thereof are possible without departing from the spirit and scope of the present disclosure.

### Example 1: Chemicals and Reagents

The following chemicals and reagents were purchased from Sigma (USA): Melamine powder (99%; C₃H₆N₆), Pyrrole monomer (98%; C₄H₄N), Iron(III) chloride (97%; FeCl₃), Diethylenediamine (99%; C₄H₁₀N₂), Isophthaloyl dichloride (99%; C₆H₄-1,3(COCl)₂)). A local supplier was used to obtain organic solvents like n-hexane, ethanol, and methanol (Fisher Scientific). The alumina ceramic supports were purchased from HIGHBORN New Materials Co., LTD, China.

### Example 2: Synthesis of Polypyrrole-Loaded Graphitic Carbon Nitride (PPy-G-C₃N₄)

A simple wet impregnation process combined with a thermal pyrolysis/exfoliation procedure was used to prepare the polypyrrole-loaded graphitic carbon nitride using locally synthesized polypyrrole (PPy) and bulk-graphitic carbon nitride (bulk-G-C₃N₄). Initially, pyrrole was used as the monomer in the oxidative polymerization process to prepare the polypyrrole (PPy) powder, with FeCl₃ acting as the oxidizing agent [Baig, U.; Gondal, M. A.; Dastageer, M. A.; Sajid, M. Maghemite Nanoparticles Decorated Semiconducting Graphitic Carbon Nitride Hetero-Structured Nanocomposite: Facile Synthesis, Characterizations and Its Visible Light Active Photocatalytic System for Removal of Hazardous Organic Pollutants from Aqueous Solutions. Colloids Surfaces A Physicochem. Eng. Asp. 2022, 641, 128427]. Additionally, utilizing the thermal pyrolysis method with melamine as the starting material, bulk-G-C₃N₄ was also synthesized [Baig, U.; Rao, R. A. K.; Khan, A. A.; Sanagi, M. M.; Gondal, M. A. Removal of Carcinogenic Hexavalent Chromium from Aqueous Solutions Using Newly Synthesized and Characterized Polypyrrole-titanium(IV)Phosphate Nanocomposite. Chem. Eng. J. 2015, 280, 494-504]. After the preparation of PPy and bulk-G-C₃N₄, PPy powder was ultrasonically processed in an ethanol solvent before being combined with bulk-G-C₃N₄ powder to form a homogeneous PPy/bulk-G-C₃N₄ paste and then thermally pyrolyzed/exfoliated at 350° C. in an air oven for 24 h to obtain the polypyrrole loaded graphitic carbon nitride (PPy-G-C₃N₄).

### Example 3: Fabrication of PPy-G-C₃N₄/PA@Alumina Ceramic Membrane

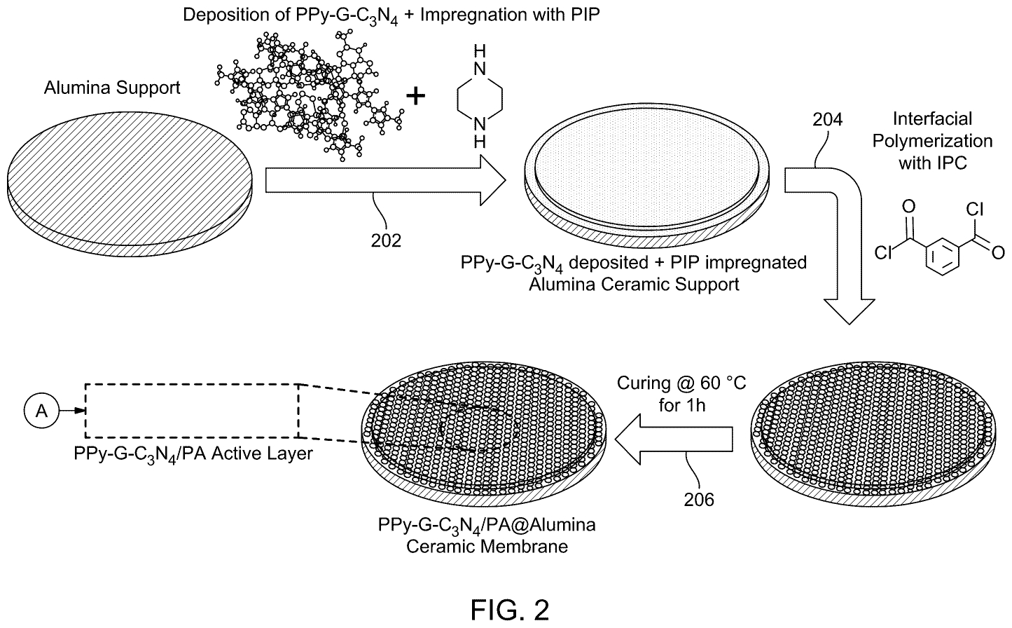

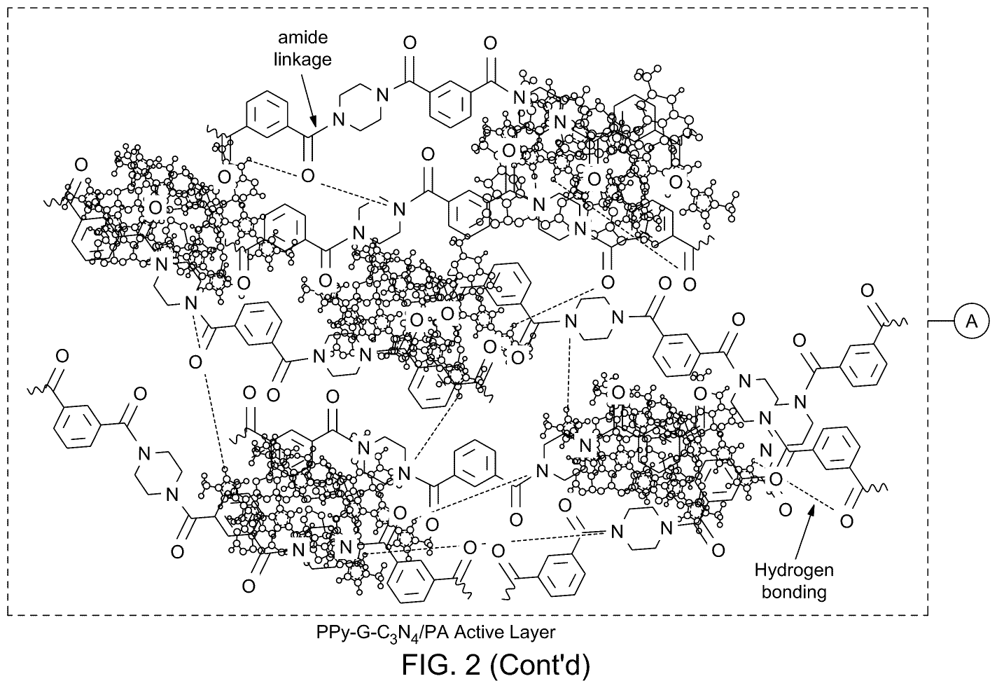

For the fabrication of PPy-G-C₃N₄/PA@alumina ceramic membrane, initially, an alumina support was fixed in a dead-end-filtration cell (Sterlitech). Then, the cell was filled with a 100 mL aqueous solution of 2% wt./v PIP containing 100 mg highly dispersed PPy-G-C₃N₄. The dispersion of PPy-G-C₃N₄ with PIP aqueous solution was prepared by probe ultrasonication for 30 min (see a process 202 of FIG. 2). The alumina support was subjected to this dispersion while maintaining a constant N₂ gas pressure of 1 bar. To deposit the dispersed PPy-G-C₃N₄ on the alumina support and simultaneously impregnate the alumina support with PIP, the solution was forced to flow through the ceramic support by the N₂ pressure, and then PPy-G-C₃N₄ deposited and PIP impregnated alumina membrane was dried in an oven for 15 min at 60° C. Interfacial polymerization (IP) was performed on the dried PPy-G-C₃N₄ deposited and PIP-impregnated alumina membrane using 0.15% TPC (wt./v) cross-linker in an n-hexane solution. After 20 min of IP reaction, the membrane was removed from the TPC solution and washed with fresh n-hexane to eliminate unreacted monomers (see a process 204 of FIG. 2). The membrane was then cured at 60° C. for 1 h in a heating oven, producing the PPy-G-C₃N₄/PA@alumina ceramic membrane (see a process 206 of FIG. 2). The processes adopted during membrane fabrication are given in FIG. 2.

### Example 4: Characterization

The formation of polypyrrole loaded graphitic carbon nitride nanosheets (PPy-G-C₃N₄) was confirmed by using X-ray diffraction (XRD, MiniFlex-600, Rigaku, 3 Chome-9-12 Matsubaracho, Akishima, Tokyo 196-8666, Japan), field emission transmission electron microscope (FE-TEM, JEM2100F, JEOL, Akishima, Tokyo, Japan), Fourier transform infrared spectrometer (ATR-FTIR, Nicolet iS-50, Thermo Fisher Scientific, Waltham, Massachusetts, Unites States) and scanning electron microscopy coupled with energy dispersive X-ray spectroscopy (SEM/EDX, Coxem EM-30AX SEM, Migun Techno World, 1Cha, 201, 199 Techno 2-ro, Yuseong-gu, Daejeon, South Korea). The PPy-G-C₃N₄/PA@alumina ceramic membrane and its alumina ceramic support were also characterized by using XRD, ATR-FTIR, SEM/EDX, and a goniometer (KRUSS, DSA25, Hamburg, 85 Borsteler Chaussee, Germany).

### Example 5: Filtration Experiments

The ability of the PPy-G-C₃N₄/PA@alumina ceramic membrane to separate an oil-in-water emulsion was tested using a dead-end filtration setup. Diesel oil (1 g) and water (1 L) were blended with 500 mg sodium dodecyl sulfate (SDS) as a surfactant using a shear mixer working at 30000 rpm to prepare the stock feed solution of 1000 ppm oil-in-water emulsion. Using the stock feed solution (1000 ppm oil-in-water emulsion), three different feed solutions of 50 ppm, 100 ppm, and 200 ppm oil-in-water emulsions were prepared to see the effect of different feed concentrations on the membrane permeate flux and separation efficiencies. The pure water flux, flux, and separation efficiency at different pressure and with different concentration of oil-in-water emulsions and stability of the membrane with time were evaluated and calculated according to reports described in Baig, U et al. [Waheed, A.; Baig, U.; Abussaud, B.; Aljundi, I. H. Fabrication of Supported Carbide-Derived-Carbon Membrane by Two Phases of Interfacial Polymerization for Oil/Water Separation. Ceram. Int. 2021].

### Results and Discussion

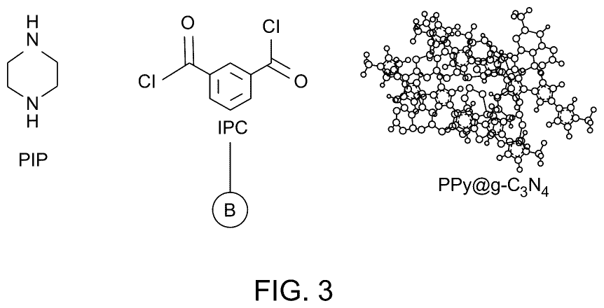

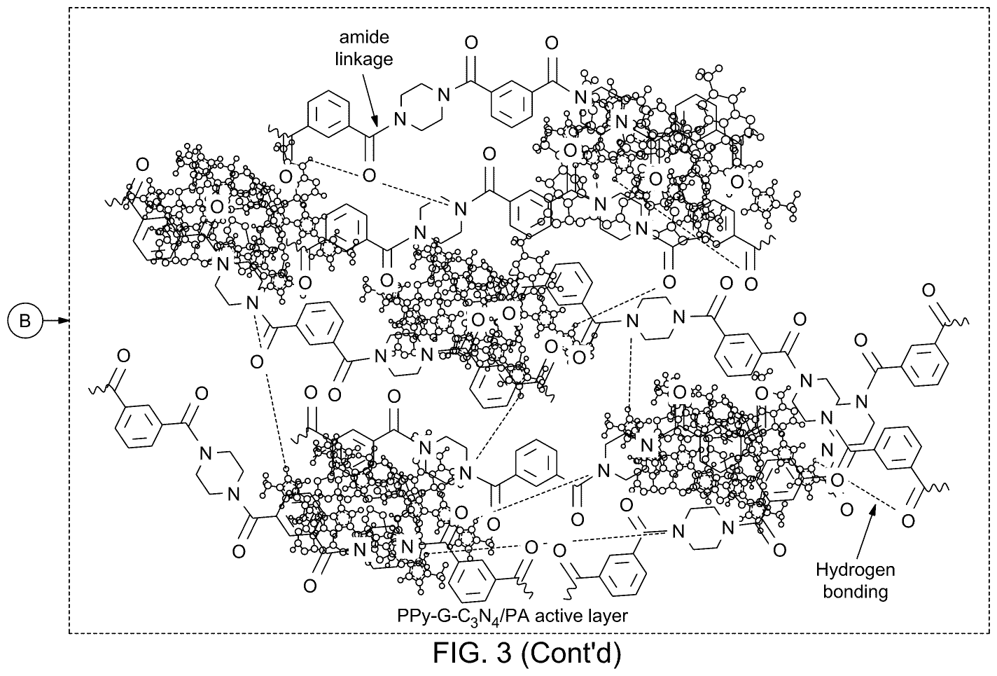

The possible reaction, along with the proposed structures of the active layer is given in FIG. 3. From FIG. 3 it can be observed that a facile reaction occurs between amino groups (—NH) of PIP and acid chloride (—COCl) of IPC, leading to the formation of a polyamide having linear chains. Moreover, the presence of multiple amino groups (—NH) in the structure of pyrrole units of PPy and triazine unit of G-C₃N₄, the reaction also occurs between PPy-G-C₃N₄ and IPC, resulting in its stable decoration in the polyamide network. Similarly, multiple hydrogen bonds are possible between PPy-G-C₃N₄ and the polyamide active layer shown in FIG. 3.

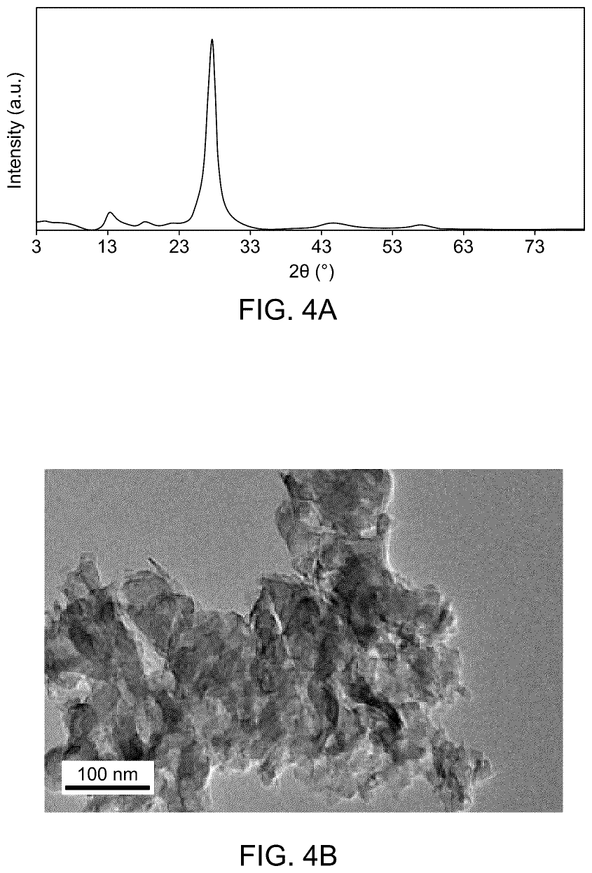

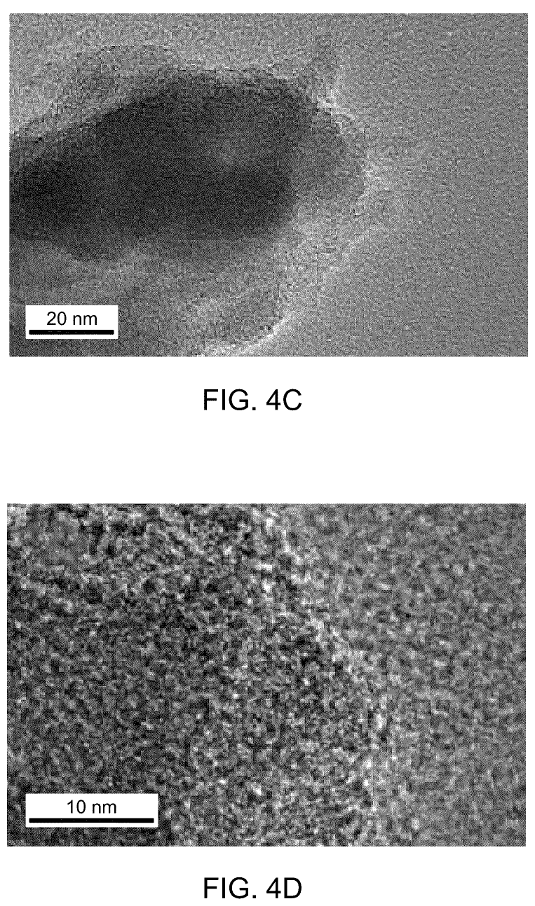

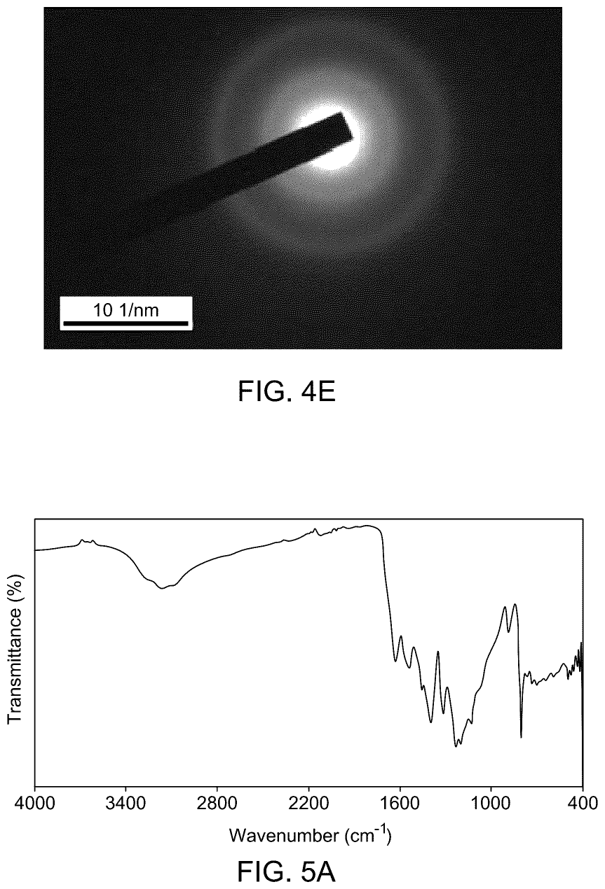

Following the synthesis of G-C₃N₄, its structural features were revealed through several characterization techniques. PXRD confirmed the exixtance of all of the planes that have been identified previously in literature [Fina, F.; Callear, S. K.; Carins, G. M.; Irvine, J. T. S. Structural Investigation of Graphitic Carbon Nitride via XRD and Neutron Diffraction. Chem. Mater. 2015, 27, 2612-2618]. The characteristics peaks associated with G-C₃N₄ were identified at 2θ=13.00° and 27.40° (FIG. 4A). The peak at 2θ=13.00° is attributed to 100 plane with a d-spacing of 0.680 nm which is due to intra-layer d-spacing. The other peak at 2θ=27.40° is due to the 002 plane with a d-spacing of 0.326 nm. This d-spacing is due to the inter-layer distance between the layers of G-C₃N₄. TEM and HRTEM of G-C₃N₄ confirmed the nanosheet structure (FIG. 4B-FIG. 4D), which was further magnified to see the layering of the sheets in the bulk structure. FIG. 4C showed that the layers were stacked on each other, and this pattern becomes more clear towards the edges. Upon further zooming in, the G-C₃N₄ nanosheets appeared highly porous, with nanopores distributed throughout the structure of the synthesized G-C₃N₄. Infact, the G-C₃N₄ nanosheets appear spongy, which is a highly desirable feature for filtration applications such as membrane-based separations. The selected area electron diffraction (SAED) further confirmed the crystallinity of the synthesized G-C₃N₄ (FIG. 4E). The SAED pattern revealed that G-C₃N₄ grew in a polycrystalline pattern with concentric circular fringes. In the SAED pattern, the interlayer spacing between different layers of the resin is quite obvious. Hence, interlayer spacing is also a desirable feature required for membrane separation applications.

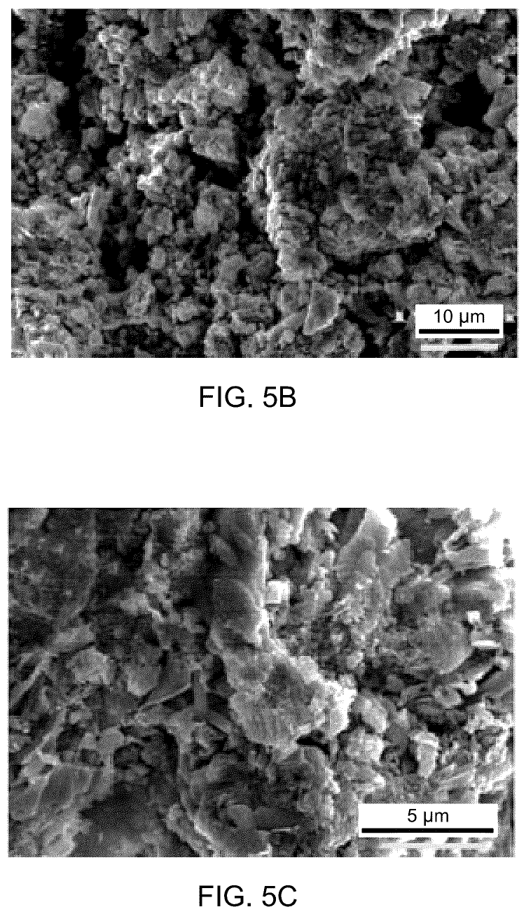

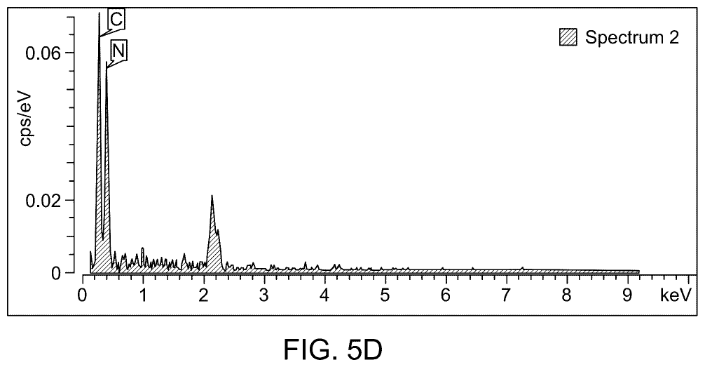

After the synthesis and structural characterization of G-C₃N₄ nanosheets, its composite with PPy was synthesized. The PPy@G-C₃N₄ composite was also thoroughly characterized, as discussed below. FTIR spectrum of PPy@G-C₃N₄ showed the presence of all the characteristics peaks (FIG. 5A). One of the most important peaks confirmed PPy was the broad —N—H stretching peak spanning from 3500 cm⁻¹ to 3000 cm⁻¹ [Baig, U.; Gondal, M. A.; Alam, M. F.; Laskar, A. A.; Alam, M.; Younus, H. Enzyme Immobilization and Molecular Modeling Studies on an Organic-inorganic Polypyrrole-titanium(IV)Phosphate Nanocomposite. New J. Chem. 2015, 39, 6976-6986], which overlaps the N—H bonds of triazine rings of melamine. The intense bands at around 1620 cm⁻¹, 1570 cm⁻¹ and 1400 cm⁻¹ were assigned to aromatic C═C, C—C, and C—N bond stretching of G-C₃N₄ triazine and pyrrole rings of PPy@G-C₃N₄ composite. Similarly, the C—N stretching of the pyrrole ring appeared at around 1350 cm⁻¹.

The surface morphology of the PPy@G-C₃N₄ composite was analyzed by SEM analysis of the composite (FIG. 5B and FIG. 5C). The SEM images showed that G-C₃N₄ nanosheets were embedded in the matrix of the PPy polymer. The PPy@G-C₃N₄ composite appeared as a complete mix of G-C₃N₄ nanosheets and PPy polymer because of in-situ polymerization of the PPy in the presence of the G-C₃N₄ nanosheets. This coherence in the components of the PPy@G-C₃N₄ composite is due to the similar structural features of pyrrole and melamine monomers, because both monomers have aromatic rings as part of their structure along with nitrogen atom being the structural component of each monomer. Hence, the resultant PPy and G-C₃N₄ polymers develop considerable interactions, such as hydrogen bonding and hydrophobic-hydrophobic interactions between the aromatic rings. The elemental composition of the synthesized PPy@G-C₃N₄ composite was also analyzed by EDX, as shown in FIG. 5D. The EDX analysis confirmed the presence of two elements such as carbon (C) and nitrogen (N), being the constituent elements of PPy@G-C₃N₄.

As can be seen, the membrane of the present disclosure can be porous. The porosity of the membrane plays an important critical role in the filtration performance of the fabricated membrane. The membrane of the present disclosure can have pores with an average size of 0.1-5 μm, preferably 0.2-4 μm, preferably 0.3-3 μm, preferably 0.4-2 μm, preferably 0.5-1 μm. Based on the size-exclusion principle, molecules and/or particles that are bigger than the pore size of the membrane are rejected by the pores at the membrane surface while molecules (e.g. water molecules) and/or particles smaller than the pore size of the membrane can pass through the pores, therefore permeating through the membrane. As a result, the pores herein are configured to let water molecules pass through while rejecting micro-sized oil droplets that have an average diameter of 10-100 μm, preferably 30-80 μm, preferably 40-70 μm, preferably 50-60 μm.

Separation efficiency is a measure of the percentage of oil particles that do not pass through the membrane. A flux rate is a measure of the volume of a feed liquid (e.g. a mixture of water and oil) processed by the membrane within a given time. When the average size of the pores is within the ranges as discussed above, the separation efficiency can be above 95%, preferably above 97%, preferably above 99% while the flux rate can be 70-700 L m⁻²h⁻¹ (LMH), preferably 80-650 LMH, preferably 90-500 LMH, preferably 100-400 LMH, preferably 200-300 LMH, for example at a pressure of 8 bars. When the average size of the pores is above the higher limit(s) as discussed above, the flux rate may further increase. However, the separation efficiency may significantly decrease, for example to below 80%, below 60%, below 40% or even 0%, rendering the membrane unsuited for oil separation purposes.

When the average size of the pores is below the lower limit(s) as discussed above, the separation efficiency may be marginally improved. However, due to smaller pores, the flux rate will significantly decrease, for example to below 50 LMH, e.g., 5-40 LMH, 10-30 LMH or 15-25 LMH under the same pressure of 8 bars, thus negatively affecting the throughput of the membrane filtration process and rendering the membrane unsuited for industrial oil separation applications. Particularly, in the aforementioned Baig reference (“Fabrication of polypyrrole-graphitic carbon nitride nanocomposite containing hyper-cross-linked polyamide photoresponsive membrane with self-cleaning properties for water decontamination and desalination applications,” Journal of Water Process Engineering, Volume 47, 102721), a tetra-amine leads to a highly crosslinked and tight polymer network. Therefore, Baig's membrane has pores with an average size of below 10 nm, preferably below 5 nm, preferably below 1 nm. Accordingly, Baig's membrane is used as a nanofiltration membrane for filtering salts, which are orders of magnitude smaller than oil particles in the present disclosure. Notably, the maximum water flux of Baig's membrane was found to be 78.57 LMH at 25 bars, which is over three times of 8 bars, a pressure condition used in the present disclosure. As a skilled artisan would understand, substituting Baig's salt solutions with a mixture of water and oil may further decrease the maximum flux rate as oil particles are orders of magnitude larger than salts.

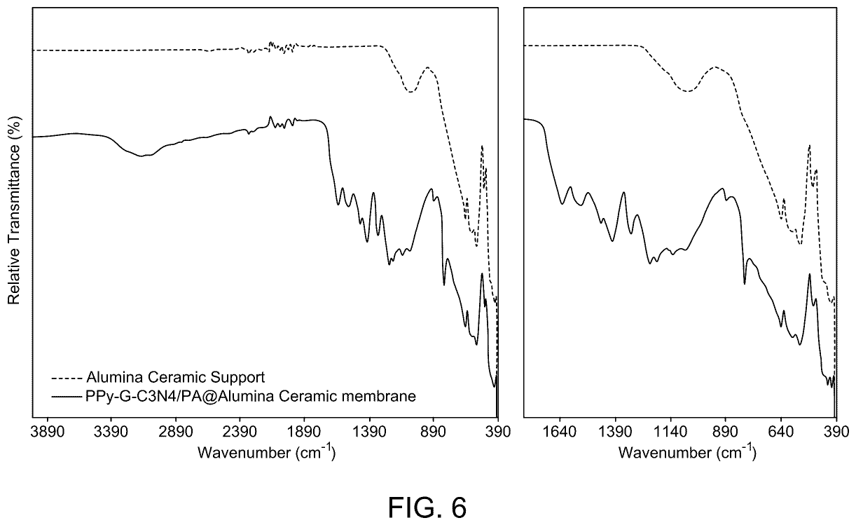

Following the synthesis of the PPy@G-C₃N₄ composite, the composite was used to decorate as a selective layer on the alumina ceramic support. The PPy@G-C₃N₄ was deposited through an IP reaction between PIP and IPC. The structural and morphological features of the resultant PPy-G-C₃N₄/PA@alumina ceramic membrane were established through several characterization techniques, as discussed below. The FTIR spectra of both bare alumina support and PPy-G-C₃N₄/PA@alumina ceramic membrane were recorded as shown in FIG. 6. The bare alumina membrane showed peaks at around 1000 cm⁻¹ and 500 cm⁻¹ due to Al—O bond stretching. Upon decoration of PPy@G-C₃N₄ through IP, the PPy-G-C₃N₄/PA@alumina ceramic membrane showed the peaks of both PPy@G-C₃N₄ and alumina. The observation of all the characteristic peaks of all the components confirmed the successful fabrication of PPy-G-C₃N₄/PA@alumina ceramic membrane.

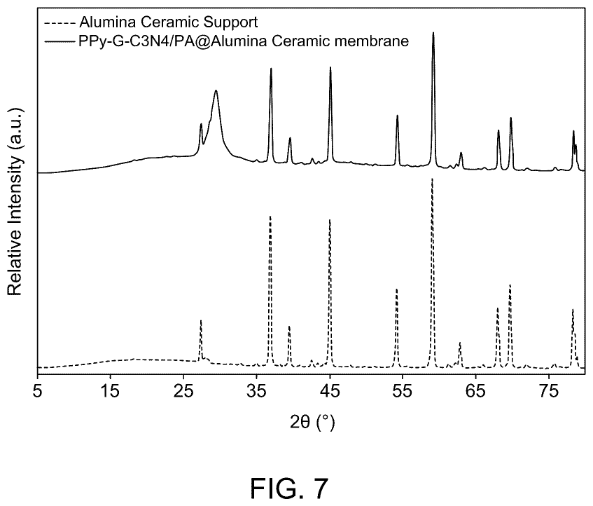

The wide angle XRD of the ceramic alumina support as shown in FIG. 7 exhibited all the peaks of the ceramic support as has been identified in the literature [Waterhouse, G. I. N.; Chen, W. T.; Chan, A.; Jin, H.; Sun-Waterhouse, D.; Cowie, B. C. C. Structural, Optical, and Catalytic Support Properties of γ-Al₂O₃Inverse Opals. J. Phys. Chem. C 2015, 119, 6647-6659]. In the case of PPy-G-C₃N₄/PA@alumina ceramic membrane, a wide peak appeared at 28° which is attributed to a polymeric framework of polyamide generated due to the reaction of amine with acid chloride. In addition to the polymeric peak of polyamide, all the peaks due to alumina support were also found in the XRD of the PPy-G-C₃N₄/PA@alumina ceramic membrane. Another finding was the masking of the peaks of ceramic alumina support, showing that all the phases of the alumina support were covered by PPy-G-C₃N₄/PA active layer (FIG. 7). These observations also confirmed the growth of PPy-G-C₃N₄/PA active layer onto the alumina ceramic support.

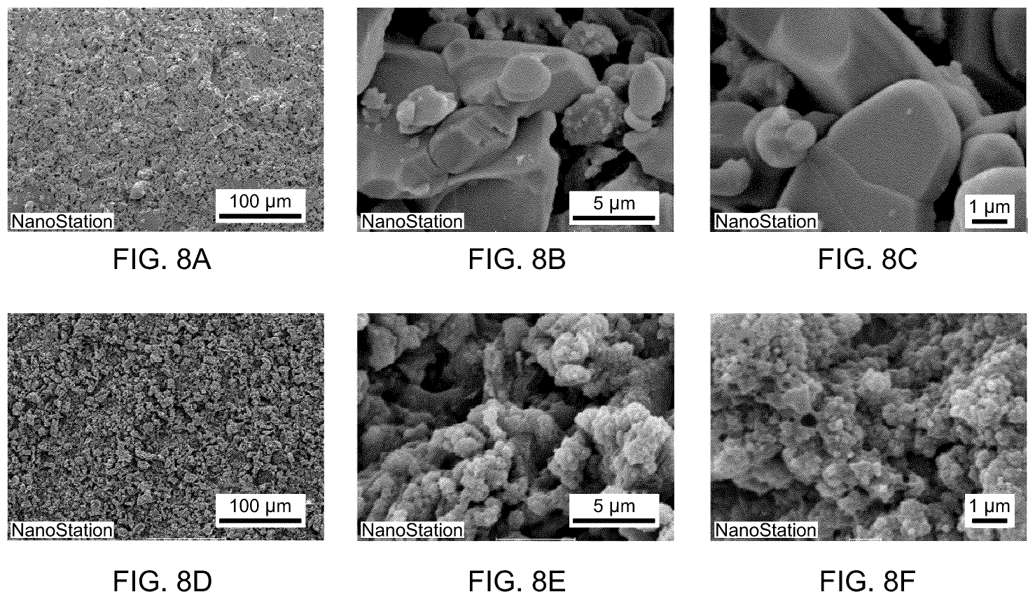

To dig further into the structural features of the PPy-G-C₃N₄/PA@alumina ceramic membrane, SEM micrographs of PPy-G-C₃N₄/PA@alumina ceramic membrane along with alumina ceramic support were recorded at different magnifications shown in FIGS. 8A-8F. The low magnification micrograph of alumina ceramic support (FIG. 8A) exhibited very fine particles distributed throughout the entire membrane area. The surface of these particles appeared quite smooth with irregular shapes and sizes along with numerous micropores (FIG. 8B and FIG. 8C). Upon the growth of PPy-G-C₃N₄/PA active layer on the alumina ceramic support, the surface morphology of the PPy-G-C₃N₄/PA@alumina ceramic membrane appeared quite altered because of the formation of larger sized granular particles (FIG. 8D-8F). Moreover, the surface of the particles in the case of PPy-G-C₃N₄/PA@alumina ceramic membrane also appeared quite rough compared to bare alumina ceramic support. In addition, the pores also narrowed down to a larger extent, which confirms that the PPy-G-C₃N₄/PA active layer has grown considerably to an extent required for separation.

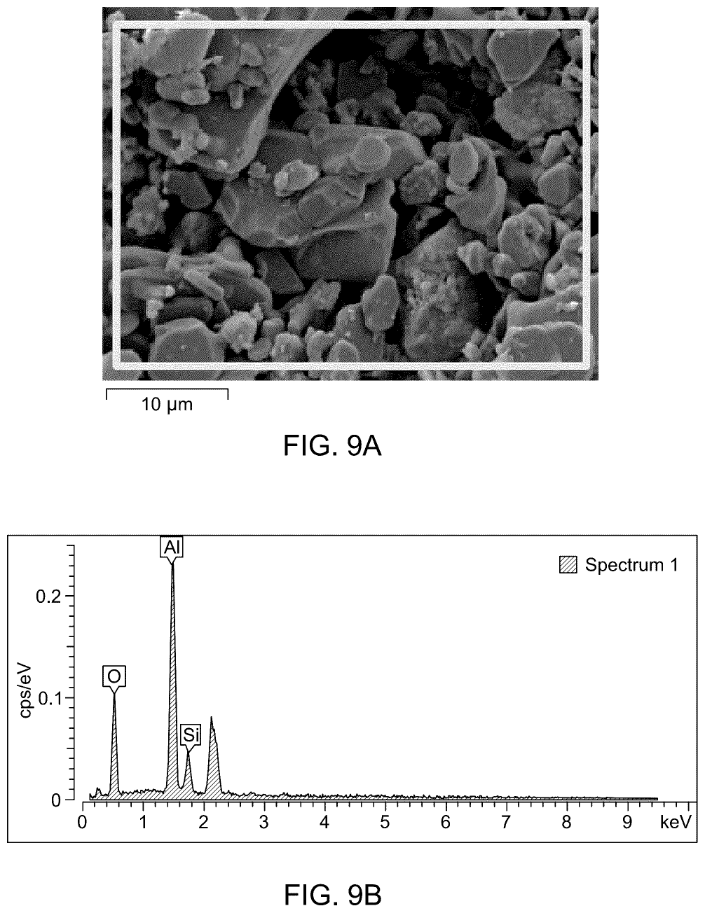

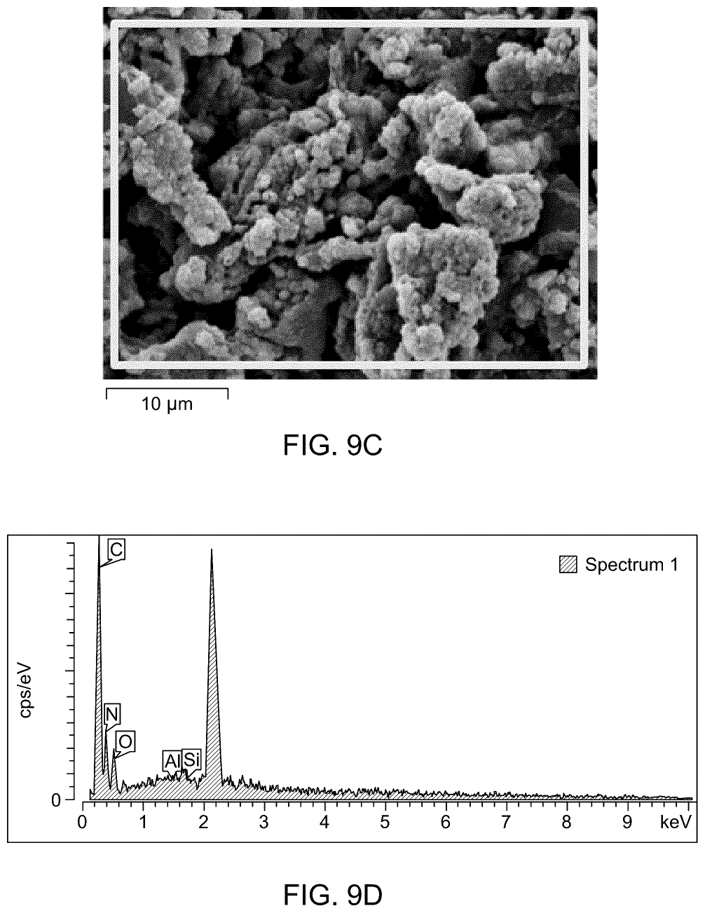

EDX analysis of the alumina ceramic support (FIG. 9A and FIG. 9B) exhibited an elemental composition of oxygen (O), aluminum (Al) and silicon (Si) (FIG. 9B). Similarly, EDX analysis of PPy-G-C₃N₄/PA@alumina ceramic membrane (FIG. 9C and FIG. 9D) showed an elemental composition of O, Al, Si along with two additional elements Carbon (C) and Nitrogen (N) which are attributed to the growth of polyamide. Hence, all of the anticipated elements—C, N, O, Al, and Si were found in the PPy-G-C₃N₄/PA@alumina ceramic membrane (FIG. 9D), which is another evidence confirming the growth of PPy-G-C₃N₄/PA active layer.

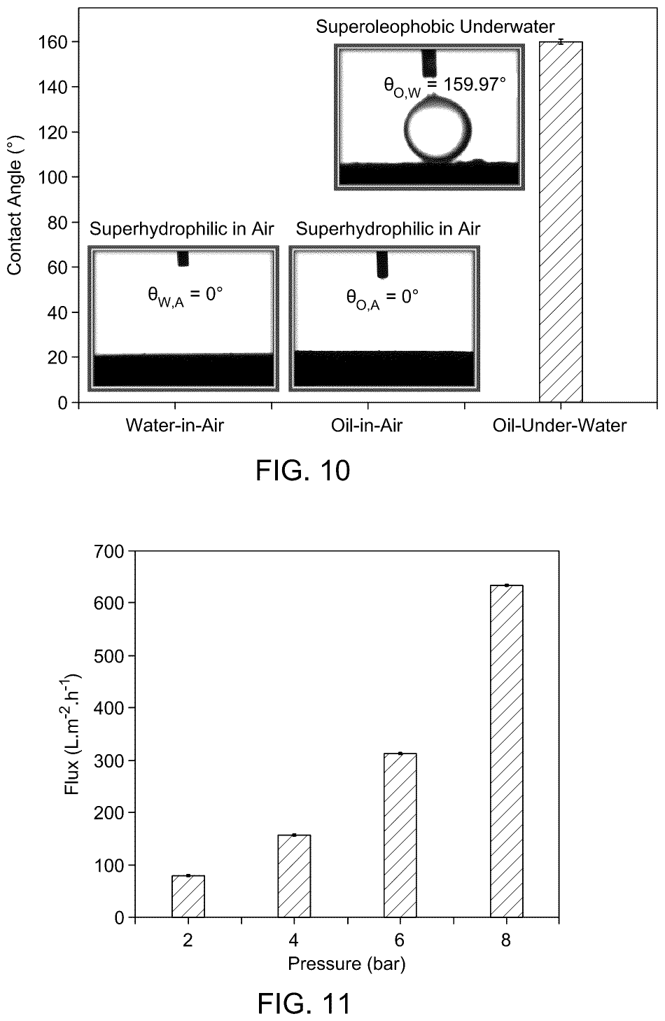

One feature of the membrane surface is the surface wettability of the membrane. The surface wettability can determine the fate of the membrane fouling during filtration experiments. In this regard, the water contact angle (WCA) and oil contact angle (OCA) of the membrane were measured in air. In the case of WCA in air (θ_{W,A}) and OCA in air (θ_{O,A}), the membrane appeared both superhydrophilic and superoleophilic as the θ_{W,A} and θ_{O,A} were recorded to be approximately 0° shown in FIG. 10. This behavior can be explained by the presence of hydrophilic polyamide/G-C₃N₄ present on the surface of the alumina ceramic support. Another relevant feature for the oil separating membranes is the underwater superoleophobicity of the membrane surface. To ascertain the underwater superoleophobicity of the membrane surface, the underwater OCA (θ_{O,W}) of the PPy-G-C₃N₄/PA@Alumina ceramic membrane was measured to be θ_{O,W}=159.97° as shown in FIG. 10. Due to underwater superoleophobic nature of the PPy-G-C₃N₄/PA@alumina ceramic membrane, a strong hydration layer is developed onto the membrane surface which does not allow oil to pass through the PPy-G-C₃N₄/PA@alumina ceramic membrane. However, the water can permeate through the membrane, resulting in the separation of O/W emulsion.

After thoroughly studying various features of the PPy-G-C₃N₄/PA@alumina ceramic membrane, filtration experiments were carried out to explore the separation potential of the PPy-G-C₃N₄/PA@alumina ceramic membrane. At the beginning of the filtration experiments, the PPy-G-C₃N₄/PA@alumina ceramic was compacted using DI water as feed at a transmembrane pressure of 8 bar. Following compaction, the effect of transmembrane pressure on permeate flux was measured, as shown in FIG. 11. A linear relationship between applied transmembrane pressure and flux was found, which is obvious for any membrane under filtration conditions. At a pressure of 8 bar, the permeate flux of the PPy-G-C₃N₄/PA@alumina ceramic membrane reached 650 L m⁻²h⁻¹ (LMH).

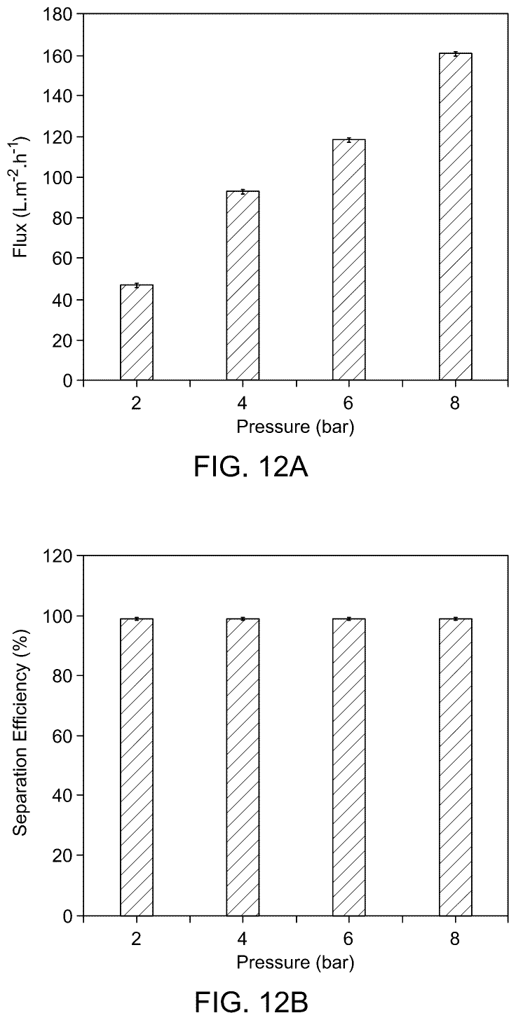

To explore the potential of O/W emulsion separation, the PPy-G-C₃N₄/PA@alumina ceramic membrane was tested against 100 ppm O/W emulsion. The flux declined in the case of oil-containing feed because compared to DI water flux (650 LMH), the flux using O/W emulsion was found to be 160 LMH at 8 bar (FIG. 12A). This decline in permeate flux can be attributed to fouling of the membrane surface with oil as the oil is emulsified in the form of small droplets and reaches the membrane surface inevitability. However, the O/W emulsion separation efficiency of the PPy-G-C₃N₄/PA@alumina ceramic membrane stayed nearly at >99% at all the tested membrane pressure, yielding clean water as a permeate (FIG. 12B).

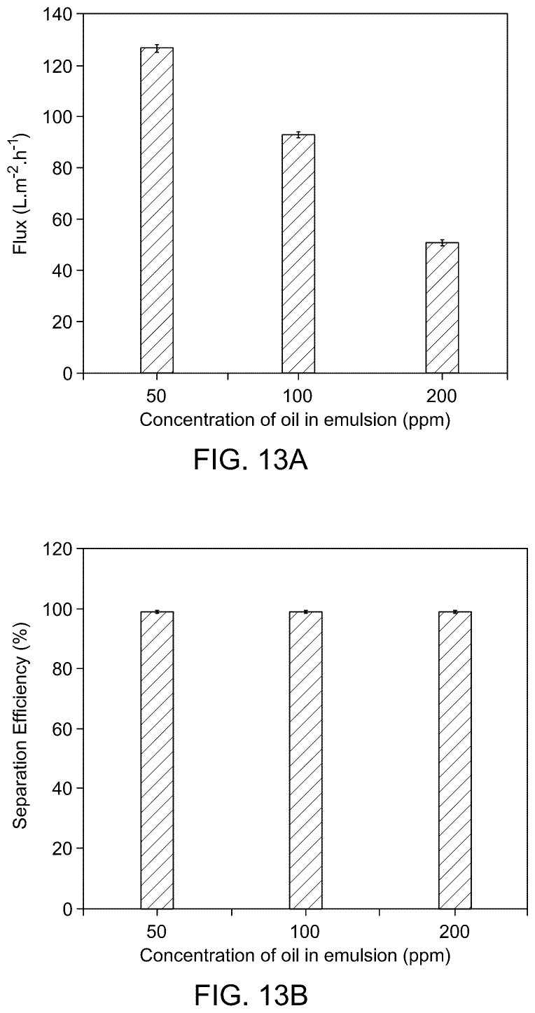

Going further into the performance testing of the fabricated PPy-G-C₃N₄/PA@alumina ceramic membrane, the effect of increasing oil concentration on the performance of the membrane was analyzed. With increasing oil concentration, the permeate flux started to decline and reached 45 LMH when oil concentration was raised to 200 ppm compared to the higher flux of 130 LMH for 50 ppm (FIG. 13A). This is attributed to fouling of the membrane surface due to oil wetting the surface of the membrane leading to cake formation. However, the O/W emulsion separation performance of the PPy-G-C₃N₄/PA@alumina ceramic membrane remained considerably high at >99% for all of the tested emulsions (FIG. 13B).

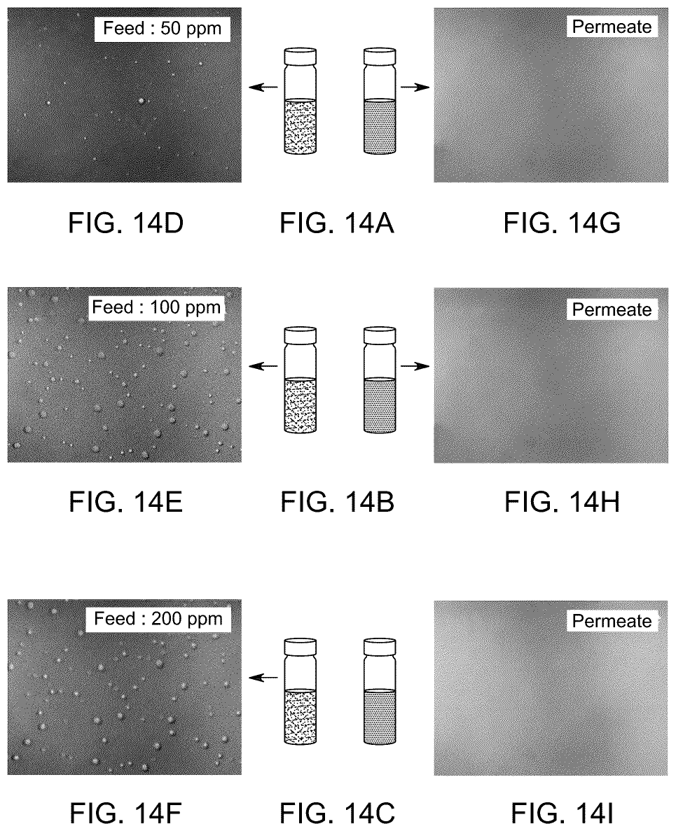

The experimental samples of the feeds and permeates, along with optical microscopy images collected during performance analysis of the membrane, and the results of this study are depicted in FIG. 14. In the case of all the feeds, 50 ppm (FIG. 14A), 100 ppm (FIG. 14B), and 200 ppm (FIG. 14C), the oil droplets can be seen fully dispersed throughout the collected sample. Moreover, the concentration of the oil droplets in the feeds increases with increasing oil concentration. The digital photographs of the feed and permeate show that feeds (FIG. 14D, FIG. 14E, and FIG. 14F) are cloudy suspensions which became clear of any cloudiness or coloration in the case of permeates collected (FIG. 14G, FIG. 14H, and FIG. 14I). The optical microscopic images of the permeates (FIG. 14G, FIG. 14H, and FIG. 14I) also confirmed that permeates are clear of any suspended oil droplets. Hence, the PPy-G-C₃N₄/PA@alumina ceramic membrane could reject almost all the oil from the O/W emulsion even at higher oil concentrations, generating pure water as permeate.

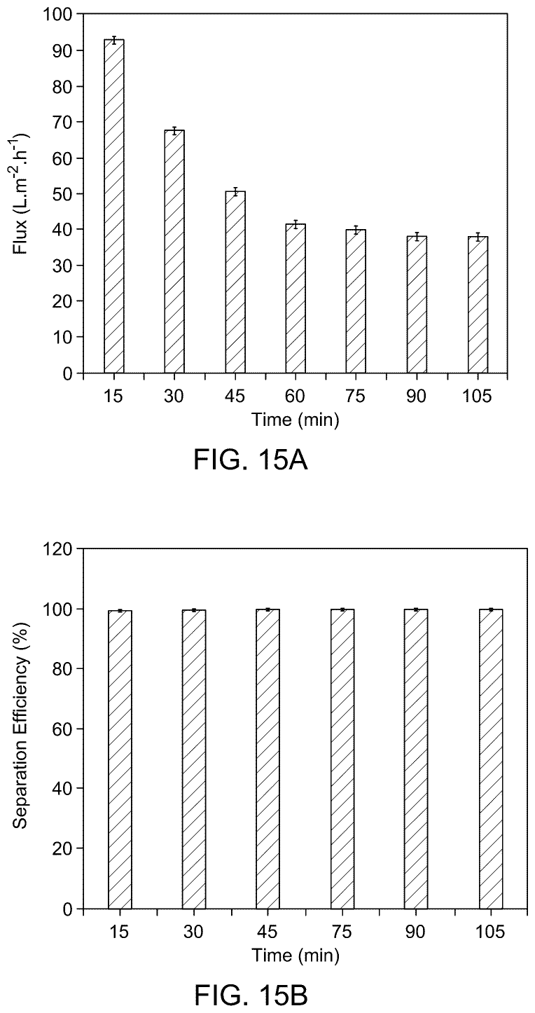

Following membrane performance studies, the stability analysis of the membrane was also studied, as shown in FIGS. 15A and 15B. As generally seen in membrane performance studies, the flux decreases considerably quickly and stabilizes. In the initial 45 minutes of filtration tests, the flux decreased from 92 LMH to 50 LMH, and after 60 minutes of filtration tests, the flux decreased even further to 40 LMH and remained stable for the duration of 105 minutes (FIG. 15A). The initial rapid decline in permeated flux is due to the formation of a fouling layer which grows quite quickly in the beginning of filtration experiments. On the other hand, the separation efficiency of the membrane remains considerably high at >99% over the entire period of membrane testing, which confirmed that the membrane active layer is relatively stable under the filtration experiments (FIG. 15B).

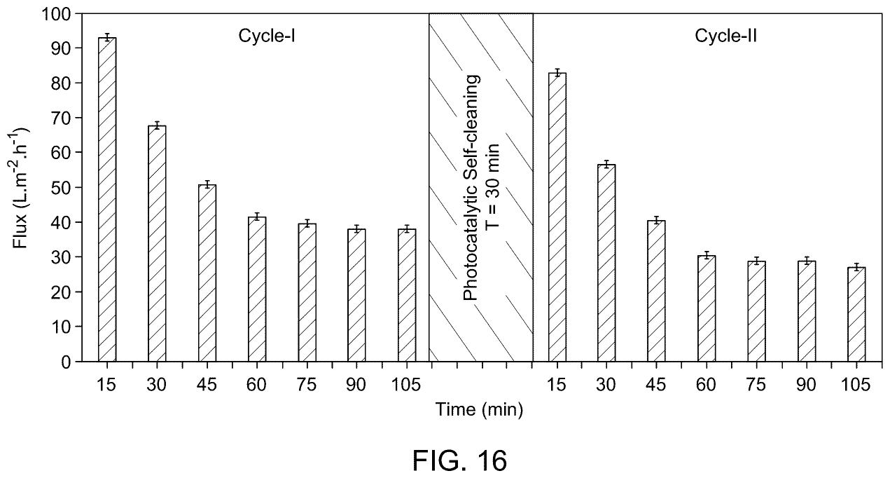

During membrane testing, it was found that membrane fouling is inevitable even though the membrane surface has special wettability features of being underwater superoleophobic. To address the challenge of membrane fouling, the fouled membrane was cleaned by exposing the membrane to a solar-simulated lamp. After undergoing photocatalytic self-cleaning, the PPy-G-C₃N₄/PA@alumina ceramic membrane was able to recover its flux from 40 LMH to 83 LMH, which was 90% recovery of the original 92 LMH for unfouled PPy-G-C₃N₄/PA@alumina ceramic membrane (FIG. 16). This might be attributed to the presence of a highly suitable photocatalyst PPy-G-C₃N₄ in the active layer of the PPy-G-C₃N₄/PA@alumina ceramic membrane supported onto alumina support. The PPy-G-C₃N₄ can efficiently degrade the oil contamination, resulting in cleaning of the membrane surface, which was later reflected in the recovery of the permeate flux of the membrane. Therefore, the current technique of membrane fabrication will not only yield membranes with the potential to separate O/W emulsions but also be able to self-clean and hence mitigate the membrane fouling issues.

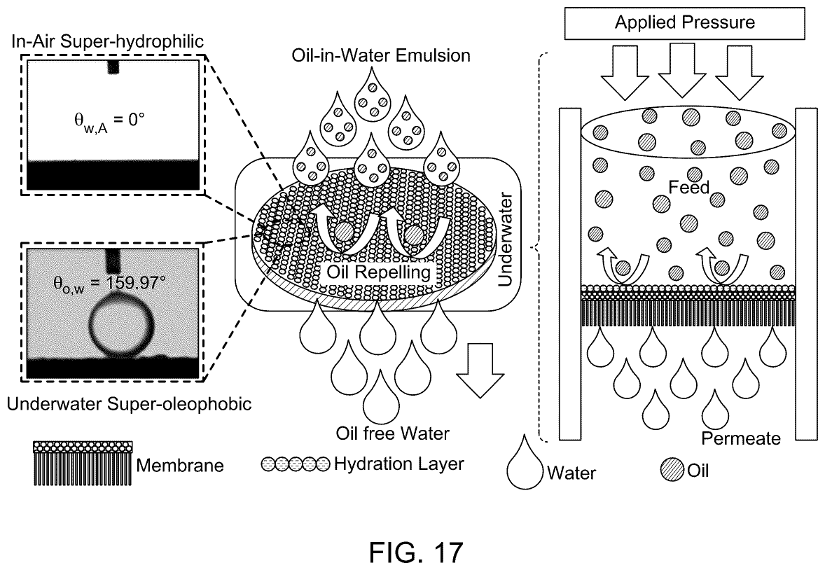

Based on the special surface wettability features of PPy-G-C₃N₄/PA@alumina ceramic membrane, the following mechanism for separation of surfactant stabilized O/W emulsion was proposed as shown in FIG. 17. Based on the measurements of WCA, the membrane surface was found to be underwater superoleophobic and hence during filtration experiments, PPy-G-C₃N₄/PA@alumina ceramic membrane allows only water to pass whereas the oil is rejected. Due to the superhydrophilic nature of the active layer of the PPy-G-C₃N₄/PA@alumina ceramic membrane, a strong hydration layer is formed at the surface of the PPy-G-C₃N₄/PA@alumina ceramic membrane. The strong hydration layer is attributed to the hydrogen bonding between the water molecules and amide linkages of the active layer of the PPy-G-C₃N₄/PA@alumina ceramic membrane. The hydration layer repels oily molecules, and hence oil cannot wet the membrane surface, which not only lowers the possibility of membrane fouling but also leads to the separation of O/W emulsion (FIG. 17).

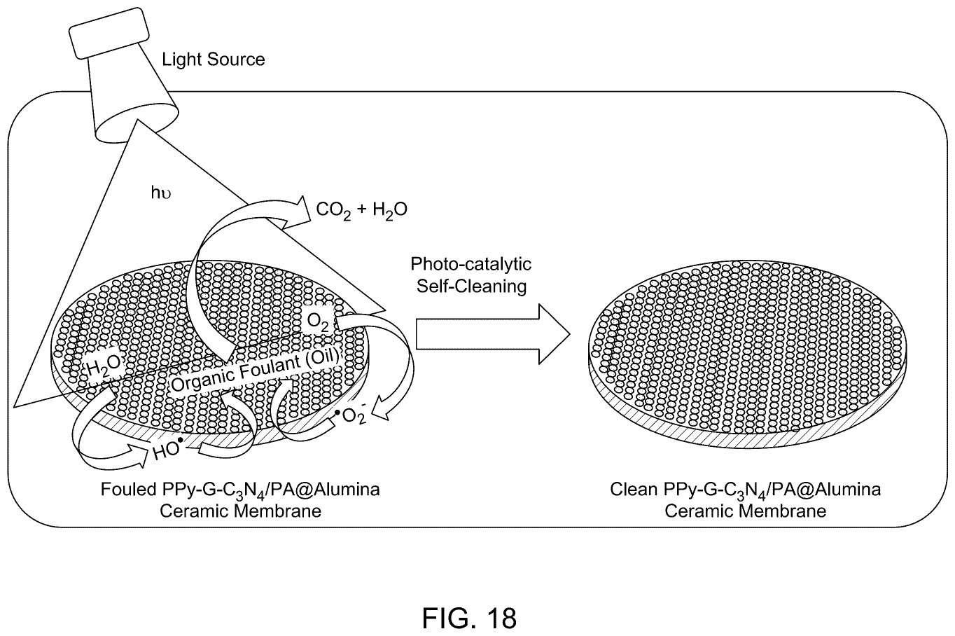

The photocatalytic self-cleaning by the PPy-G-C₃N₄/PA@alumina ceramic membrane is proposed based on the photocatalytic action of PPy-G-C₃N₄ composite (FIG. 18). As it is well-known fact that upon exposure to UV or solar light, the electrons from the valence bands of the photocatalyst are excited to conduction band leaving behind a hole which in turn oxidizes the surrounding water molecules generating highly reactive superoxide free radicals (O₂⁻) and OH. These radicals react with organic pollutants, which include oil and its components in the current experiments. The organic pollutants are readily oxidized, leading to the cleaning of the membrane surface and hence restoring the membrane's performance.

Hence, the selection and covalent decoration of an appropriate photocatalyst in the active layer of the membrane could lead to a membrane that can perform stably under experimental conditions and can self-clean its surface.

A photocatalytic self-cleaning polymeric-inorganic composite membrane was fabricated by covalently decorating the PPy-G-C₃N₄ in the polyamide active layer on an alumina microfiltration support. Initially, the PPy-G-C₃N₄ was synthesized through in-situ oxidative polymerization of pyrrole in the G-C₃N₄ matrix. The synthesized PPy-G-C₃N₄ was impregnated in the polyamide active layer of the membrane to develop a self-cleaning photocatalytic membrane. Moreover, the presence of polyamide decorated with PPy-G-C₃N₄ composite also imparted special wettability features to the PPy-G-C₃N₄/PA@alumina ceramic membrane. The PPy-G-C₃N₄/PA@alumina ceramic membrane was applied to separate O/W emulsion. The separation efficiency of the membrane was analyzed against different factors, such as increasing concentrations of oil in O/W emulsions. Similarly, the effect of increasing transmembrane pressure on the separation potential of the membranes was also analyzed. At a pressure of 8 bar, the permeate flux of the PPy-G-C₃N₄/PA@alumina ceramic membrane reached 650 L m⁻² h⁻¹ (LMH). Similarly, the separation potential of the PPy-G-C₃N₄/PA@alumina ceramic membrane stayed at nearly >99%. The fouled PPy-G-C₃N₄/PA@alumina ceramic membrane recovered 90% of its flux after photocatalytic self-cleaning experiments. Hence, the decoration of the membrane with an appropriate photocatalytic material can yield a membrane to mitigate the issue of membrane fouling.

Numerous modifications and variations of the present disclosure are possible in light of the above teachings. It is therefore to be understood that within the scope of the appended claims, the invention may be practiced otherwise than as specifically described herein.

1. A filtration membrane, comprising:
an alumina support;
a polyamide network disposed on the alumina support and formed by polycondensation between piperazine (PIP) and isophthaloyl dichloride (IPC); and
a polypyrrole-graphitic carbon nitride (PPy-G-C₃N₄) photocatalyst embedded in the polyamide network through covalent bonding, the PPy-G-C₃N₄ photocatalyst comprising nanosheets of graphitic carbon nitride (G-C₃N₄) embedded in a matrix of a polypyrrole (PPy) polymer.

2. The filtration membrane of claim 1, wherein the filtration membrane includes a plurality of pores configured to reject micro-sized oil droplets present in water while letting the water pass through.

3. The filtration membrane of claim 2, wherein the plurality of pores has an average size of 0.1-5 m.

4. The filtration membrane of claim 2, wherein the plurality of pores has an average size of 0.5-1 m.

5. The filtration membrane of claim 1, wherein the PPy polymer is covalently bonded to the polyamide network between an amino group of the PPy polymer and an acyl chloride of the polyamide network.

6. The filtration membrane of claim 1, wherein the nanosheets of G-C₃N₄ are embedded in the matrix of the PPy polymer through hydrogen bonding.

7. The filtration membrane of claim 1, wherein the filtration membrane is superhydrophilic and superoleophilic in air and superoleophobic underwater.

8. The filtration membrane of claim 1, wherein the filtration membrane includes linear chains formed by the polycondensation between PIP and IPC.

9. A method of water and oil separation, the method comprising:
filtering a mixture of water and oil through a filtration membrane to generate a water permeate, wherein the filtration membrane comprises:
an alumina support,
a polyamide network disposed on the alumina support and formed by polycondensation between piperazine (PIP) and isophthaloyl dichloride (IPC), and
a polypyrrole-graphitic carbon nitride (PPy-G-C₃N₄) photocatalyst embedded in the polyamide network through covalent bonding, the PPy-G-C₃N₄ photocatalyst comprising nanosheets of graphitic carbon nitride (G-C₃N₄) embedded in a matrix of a polypyrrole (PPy) polymer.

10. The method of claim 9, wherein the filtration membrane includes a plurality of pores configured to reject micro-sized oil droplets present in water while letting the water pass through.

11. The method of claim 10, wherein the plurality of pores has an average size of 0.1-5 m.

12. The method of claim 11, before filtering the mixture through the filtration membrane, the method further comprising:
emulsifying the mixture to form the micro-sized oil droplets.

13. The method of claim 12, wherein the micro-sized oil droplets have an average diameter of 10-100 μm.

14. The method of claim 10, wherein the plurality of pores has an average size of 0.5-1 m.

15. The method of claim 9, wherein the PPy polymer is covalently bonded to the polyamide network through an amino group of the PPy polymer and an acyl chloride of the polyamide network.

16. The method of claim 9, wherein the nanosheets of G-C₃N₄ are embedded in the matrix of the PPy polymer through hydrogen bonding.

17. The method of claim 9, wherein the filtration membrane is superhydrophilic and superoleophilic in air and superoleophobic underwater.

18. The method of claim 9, wherein the filtration membrane includes linear chains formed by the polycondensation between PIP and IPC.

19. The method of claim 1, further comprising:
exposing the filtration membrane to ultraviolet light to remove oil accumulated on the filtration membrane during the filtering; and
filtering through the filtration membrane again.

20. The method of claim 1, further comprising forming the filtration membrane by:
thermally pyrolyzing a paste of pyrrole monomers and G-C₃N₄ to obtain the PPy-G-C₃N₄ photocatalyst;
impregnating the alumina support with the PPy-G-C₃N₄ photocatalyst and PIP monomers; and
performing interfacial polymerization of PIP and IPC to form the polyamide network on the alumina support.
